(19) United States
(12) Patent Application Publication
(10) Pub. No.: US 2006/0287744 A1
(43) Pub. Date: Dec. 21, 2006

(54) Recording medium, apparatus for mixing audio data and method thereof

(76) Inventors: Kun Suk Kim, Anyang-si (KR); Jea Yong Yoo, Seongnam-si (KR)

Correspondence Address: HARNESS, DICKEY & PIERCE, P.L.C., P.O. BOX 8910, RESTON, VA, 20195, US

(21) Appl. No.: 11/450,395

(22) Filed: Jun. 12, 2006

Related U.S. Application Data
(60) Provisional application No. 60/690,523, filed on Jun. 15, 2005.
(60) Provisional application No. 60/703,462, filed on Jul. 29, 2005.
(60) Provisional application No. 60/709,807, filed on Aug. 22, 2005.

(30) Foreign Application Priority Data
Mar. 13, 2006 (KR) 10-2006-0023114

(51) Int. Cl. G06F 17/00

(52) U.S. Cl. 700/94

(57) ABSTRACT

A recording medium, apparatus for mixing audio data and method thereof are disclosed, by which various sounds can be provided according to variations of contents provided by a content provider in a manner of dynamically mixing various audio streams provided by an external input signal and/or high-density recording medium. The present invention includes a step (a) of decoding a primary audio stream and a secondary audio stream, each of the primary and secondary audio streams including at least one or more channels and a step (b) of mixing the decoded primary and secondary audio streams together, the step (b) including a step (b1) of applying a level control to the decoded secondary audio stream using a command set defined according to each channel of the secondary audio stream and a step (b2) of summing the level-controlled secondary audio stream and the decoded primary audio stream.

This application claims the benefit of the U.S. Provisional Application No. 60/690,523, filed on Jun. 15, 2005, in the name of inventor Kun Suk KIM, entitled “GENERIC METHODS OF AUDIO MIXING CONTROL”, No. 60/703,462, filed on Jul. 29, 2005, in the name of inventors Kun Suk KIM and Jea Yong YOO, entitled “PICTURE-IN-PICTURE AND INTERACTIVE MIXING CONTROL BY USING METADATA”, and No. 60/709,807, filed on Aug. 22, 2005, in the name of inventor Kun Suk KIM, entitled “METHOD FOR PROCESSING AUDIO SIGNAL AND PIP SIGNAL”, which are hereby incorporated by reference as if fully set forth herein.

This application claims the benefit of Korean Patent Application No. 10-2006-0023114, filed on Mar. 13, 2006, which is hereby incorporated by reference as if fully set forth herein.

### BACKGROUND OF THE INVENTION

1. Field of the Invention

The present invention relates to audio data mixing, and more particularly, to a recording medium, apparatus for mixing audio data and method thereof.

2. Discussion of the Related Art

Generally, optical discs capable of recording large-scale data as recording medium are widely used. Recently, a new high-density recording medium, e.g., Blu-ray disc (hereinafter abbreviated BD) has been developed to store video data of high image quality and audio data of high sound quality for long duration.

The high-density recording medium as a next generation recording medium technology is a next generation optical record solution provided with data remarkably surpassing that of a conventional DVD. And, many efforts are made to research and develop the high-density recording medium together with other digital devices.

An optical recording/reproducing apparatus with the application of the high-density recording medium specifications starts to be developed. Yet, due to the incomplete high-density recording medium specifications, the complete development of the optical recording/reproducing apparatus has many difficulties.

Specifically, in reproducing audio data included in an external input signal or a high-density recording medium, since a preferable method of mixing the audio has not been proposed or developed, many limitations are put on the full-scale development of a high-density recording medium based optical recording/reproducing apparatus.

### SUMMARY OF THE INVENTION

Accordingly, the present invention is directed to a recording medium, apparatus for mixing audio data and method thereof that substantially obviate one or more problems due to limitations and disadvantages of the related art.

An object of the present invention is to provide a recording medium, apparatus for mixing audio data and method thereof, by which various sounds can be provided according to variations of contents provided by a content provider in a manner of dynamically mixing various audio streams provided by an external input signal and/or high-density recording medium.

Another object of the present invention is to provide a recording medium, apparatus for mixing audio data and method thereof, by which the audio data are mixed using a command set stored in the recording medium.

Another object of the present invention is to provide a recording medium, apparatus for mixing audio data and method thereof, by which interactive audio is mixed using metadata stored in the recording medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of mixing audio data according to the present invention includes a step (a) of decoding a primary audio stream and a secondary audio stream, each of the primary and secondary audio streams including at least one or more channels and a step (b) of mixing the decoded primary and secondary audio streams together, the step (b) comprising a step (b1) of applying a level control to the decoded secondary audio stream using a command set defined according to each channel of the secondary audio stream and a step (b2) of summing the level-controlled secondary audio stream and the decoded primary audio stream.

The (b-1) step can further comprise a step of applying pan control to the decoded secondary audio stream using a command set.

The method can further comprise a step (c) of mixing the mixed primary and secondary audio streams and an interactive audio including at least one or more channels. And, the step (c) comprises a step (c1) of applying a level control to the interactive audio using a command set defined according to each channel of the interactive audio and a step (c2) of summing the level-controlled interactive audio and the mixed primary and secondary audio streams.

The step (c1) step can further comprise a step of applying a pan control to the interactive audio using a command set.

The method can further comprise a step (d) of mixing the mixed primary and secondary audio streams and an interactive audio including at least one or more channels. And, the step (d) comprises a step (d1) of applying a pan and/or level control to the interactive audio using mixing metadata defined according to each channel of the interactive audio and a step (d2) of summing the controlled interactive audio and the mixed primary and secondary audio streams.

In another aspect of the present invention, a method for mixing audio data comprises a step (a) of decoding a primary audio stream and a secondary audio stream, each of the primary and secondary audio streams including at least one or more channels and a step (b) of mixing the decoded primary and secondary audio streams. And, the step (b) comprises a step (b1) of applying a pan and/or level control to the decoded secondary audio stream using mixing metadata defined according to each channel of the secondary audio stream and a step (b2) of summing the controlled secondary audio stream and the decoded primary audio stream.

The mixing metadata can be included in the secondary audio stream.

In another aspect of the present invention, an apparatus for mixing audio data comprises a primary audio decoder decoding a primary audio stream including at least one or more channels, a secondary audio decoder decoding a secondary audio stream including at least one or more channels, and a first audio mixer mixing the decoded primary audio stream and the decoded secondary audio stream in a manner of applying a level control to the secondary audio stream using a command set defined according to each channel of the secondary audio stream and summing the level-controlled secondary audio stream and the decoded primary audio stream.

The first audio mixer can apply a pan control to the secondary audio stream using a command set.

The apparatus can further comprise a second audio mixer mixing the mixed primary and secondary audio streams and an interactive audio including at least one or more channels in a manner of applying a level control to the interactive audio using a command set defined according to each channel of the interactive audio and summing the controlled interactive audio and the mixed primary and secondary audio streams.

The second audio mixer can apply a pan control to the interactive audio using a command set.

The apparatus can further comprise a second audio mixer mixing the mixed primary and secondary audio streams and an interactive audio including at least one or more channels in a manner of applying a pan and/or level control to the interactive audio using mixing metadata defined according to each channel of the interactive audio and summing the controlled interactive audio and the mixed primary and secondary audio streams.

In another aspect of the present invention, an apparatus for mixing audio data comprises a primary audio decoder decoding a primary audio stream including at least one or more channels, a secondary audio decoder decoding a secondary audio stream including at least one or more channels, and a first audio mixer mixing the decoded primary audio stream and the decoded secondary audio stream in a manner of applying a pan and/or level control to the secondary audio stream using mixing metadata defined according to each channel of the secondary audio stream and summing the controlled secondary audio stream and the decoded primary audio stream.

The mixing metadata can be included in the secondary audio stream.

In another aspect of the present invention, a recording medium comprises a primary audio stream including at least one or more channels, a secondary audio stream including at least one or more channels, and a command set for a level control of the secondary audio stream mixed with the primary audio stream, the command set defined according to each channel of the secondary audio stream.

The recording medium can further comprise a command set for a pan control of the secondary audio stream mixed with the primary audio stream. And, the command set is defined according to each channel of the secondary audio stream.

The recording medium can further comprise an interactive audio including at least one ore more channels and mixing metadata for a pan and/or level control of a stream of the interactive audio mixed with the mixed primary and secondary streams. And, the mixing metadata is defined according to each channel of the interactive audio.

In a further aspect of the present invention, a recording medium comprises a primary audio stream including at least one or more channels, a secondary audio stream including at least one or more channels, and mixing metadata for a pan and/or level control of the secondary audio stream mixed with the primary audio stream. And, the mixing metadata is defined according to each channel of the secondary audio stream.

The mixing metadata can be included in the secondary audio stream.

By the present invention, audio data can be dynamically mixed according to a variation of contents. Hence, the present invention can provide more various sounds to a user.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for facilitating a conceptional understanding of the present invention;

FIG. 2 is a block diagram of an optical recording/reproducing apparatus according to the present invention;

FIG. 3 is a diagram of an audio mixing model according to the present invention;

FIG. 4 is a diagram of audio mixing of a first audio mixer according to the present invention;

FIG. 5 is a diagram of audio mixing of a second audio mixer according to the present invention;

FIG. 6 is a block diagram of a mixer according to one embodiment of the present invention;

FIG. 7 is a flowchart of an audio mixing method according to one embodiment of the present invention; and

FIG. 8 is a flowchart of an audio mixing method according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, for convenience of explanation, the present invention takes an optical disc, and more particularly, “Blu-ray disc (BD)” as an example of a recording medium. Yet, it is apparent that the technical idea of the present invention is identically applicable to other recording medium.

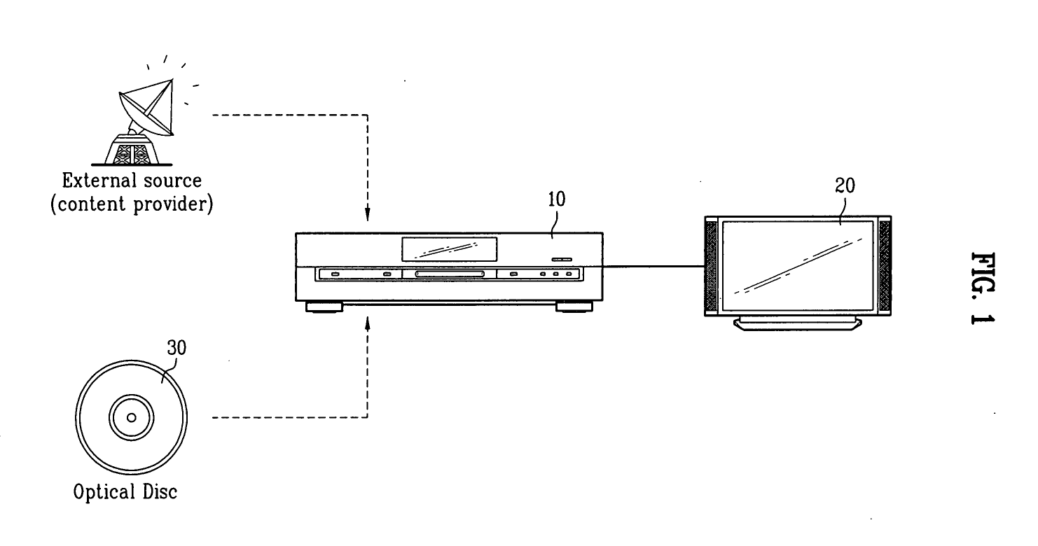

In the present invention, “storage” is a sort of a storage means provided within an optical recording/reproducing apparatus shown in FIG. 1 and means an element in which a user can randomly store necessary information and data to utilize. In particular, the storage, which is currently used in general, includes “hard disc”, “system memory”, “flash memory” or the like, which does not put limitation on the scope of the present invention.

Specifically, the “storage” is utilized as a means for storing data associated with a recording medium (e.g., Blu-ray disc). The data associated with the recording medium to be stored within the storage generally includes data downloaded from outside.

Besides, it is apparent that a permitted data directly read out of a recording medium in part or a generated system data (e.g., metadata, etc.) associated with record reproduction of the recording medium can be stored within the storage.

For convenience of explanation of the present invention, the data recorded within the recording medium shall be named “original data” and the data associated with the recording medium among the data stored within the storage shall be named “additional data”.

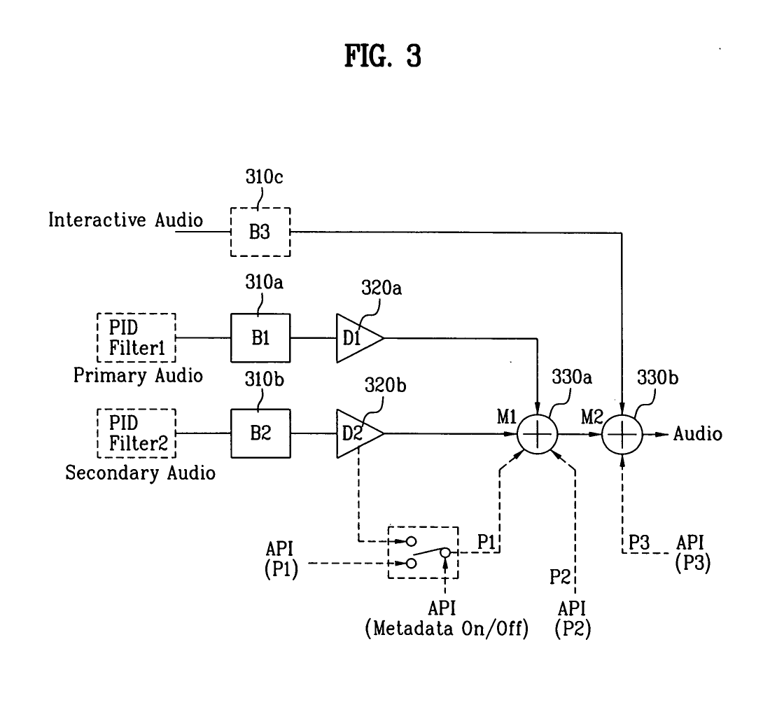

In the present invention, “panning” refers to the positioning of secondary audio signal or interactive audio within the stereo or multi-channel sound field of a primary audio. The primary, secondary and interactive audios will be explained in FIG. 3 later.

FIG. 1 is a diagram for facilitating a conceptional understanding of the present invention, in which a unified use between an optical recording/reproducing apparatus 10 and peripheral devices is exemplarily shown.

Referring to FIG. 1, “optical recording/reproducing apparatus” 10 according to the present invention enables a record or playback of an optical disc according to versatile specifications. And, the optical recording/reproducing apparatus 10 can be designed to record/play an optical disc (e.g., BD or DVD) of a specific specification.

And, it is apparent that the “optical recording/reproducing apparatus” 10 includes “drive” loadable within a computer or the like.

The optical recording/reproducing apparatus 10 according to the present invention is equipped with a function of recording/playing an optical disc 30 and a function of receiving an external input signal, performing signal-processing on the received signal, and delivering a corresponding image to a user via another external display 20. In this case, no limitation is put on the external input signal. And, a DMB (digital multimedia broadcast) signal, an Internet signal or the like can be a representative one of the external input signals. In case of Internet as an easily accessible medium, a specific data on Internet can be downloaded via the optical recording/reproducing apparatus 10 to be utilized.

Besides, an entity who provides contents is generically named “content provider (CP)”.

In the present invention, contents, which configure a title, mean data provided by a recording medium author.

The original data and the additional data will be explained in detail as follows. For instance, if a multiplexed AV stream for a specific title is recorded as an original data recorded within an optical disc and if an audio stream (e.g., English) different from the audio stream (e.g., Korean) of the original data is provided as an additional data on Internet, a request for downloading the audio stream (e.g., English) as the additional data on Internet to reproduce together with the AV stream of the original data or a request for downloading the audio stream (e.g., English) as the additional data on Internet to reproduce only will exist according to a user. To enable the requests, association between the original data and the additional data needs to be regulated and a systematic method of managing/reproducing the data according to the user's request is needed.

And, in case of reproducing an audio stream of original data and an audio stream of additional data together, an apparatus and method for mixing the streams need to be established.

For convenience of explanation in the above description, a signal recorded within a disc is named original data and a signal existing outside the disc is named additional data, which is identified according to a method of acquiring each data but does not put limitation on restricting the original or additional data to a specific data.

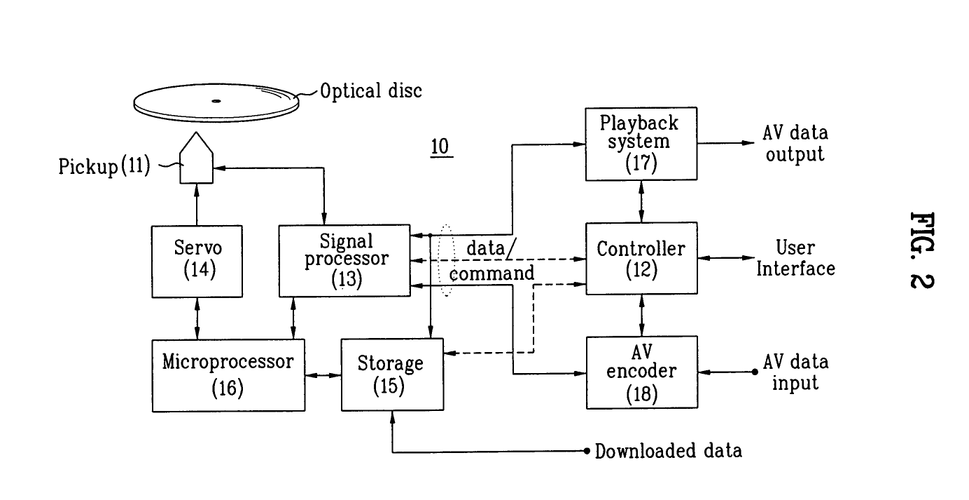

FIG. 2 is a block diagram of an optical recording/reproducing apparatus 10 according to one embodiment of the present invention.

Referring to FIG. 2, an optical recording/reproducing apparatus 10 according to one embodiment of the present invention basically includes a pickup 11 for reproducing management information including original data and reproduction management file information recorded in an optical disc, a servo 14 controlling an action of the pickup 11, a signal processor 13 restoring a reproduction signal received from the pickup 11 to a specific signal value, the signal processor 13 modulating a signal to be recorded into a signal recordable on the optical disc, the signal processor 13 delivering the modulated signal, and a microprocessor 16 controlling the overall operations.

Additional data existing on a place except an optical disc is downloaded to a controller 12 by a user command or the like. The controller 12 enables the downloaded data to be stored in storage 15 and enables additional data within the storage 15 or original data within the optical disc to be reproduced according to a user's request.

A playback system finally decodes data under the control of the controller 12 and then provides to the decoded data to a user. In particular, the playback system 17 includes a decoder decoding an AV signal and a player model that decides a play direction by interpreting a user command inputted via the controller 12.

Moreover, in order to perform a function of recording a signal in the optical disc, an AV encoder 18 converts an input signal to a signal of a specific format, e.g., an MPEG2 transport stream under the control of the controller 12 and then provides the converted signal to the signal processor 13.

FIG. 3 is a diagram of an audio mixing model according to the present invention.

Referring to FIG. 3, ‘audio mixing’ means mixing a primary audio stream with a secondary audio stream and/or an interactive audio.

An audio mixing model shown in FIG. 3 combines a primary audio stream, a secondary audio stream and an interactive audio stream together according to mixing coefficients.

The model includes a pair of audio decoders D1 and D2 and a pair of audio mixers M1 and M2 to perform decoding and mixing, respectively.

A content provider controls an audio mixing process using audio mixing control parameters (for example, P1, P2 and P3).

The primary audio is an audio stream of high bit rate for a main audio program, which is provided to the primary audio decoder (D1). The primary audio generally includes a movie sound track included in a recording medium. Yet, the primary audio can be stored in storage 15 by being downloaded from a network. A necessary primary audio transport stream (TS) is outputted from transport streams according to PID (packet identifier) in a PID filter 1 and is then provided to a primary audio decoder 320a via a first buffer (B1) 310a.

The secondary audio is a low bit rate audio stream providing a supplementary audio synchronized and mixed with the primary audio. The secondary audio may be a director's commentary or supplementary audio stream designed to be mixed with the primary audio and generally exists in storage of an optical recording/reproducing apparatus. A necessary secondary audio TS is selected by a PID filter 2 and is then provided to a secondary audio decoder 320b via a second buffer (B2) 310b.

The interactive audio is an LPCM audio activated by an application. The interactive audio is provided to a second audio mixer 330b via a third buffer (B3) 310c to be mixed with the primary audio. In case that the secondary audio is provided as a portion of an audio effect, the primary audio is mixed with the interactive audio after having been mixed with the secondary audio. The interactive audio stream is able to exist on a storage or recording medium. And, the interactive audio stream is used in providing dynamic such a sound associated with an interactive application as a button sound in general.

‘D1’ indicates the primary audio decoder 320a. ‘D1’ decodes the primary audio stream to LPCM (linear pulse code modulation). ‘D1 (320a)’ may be configured to decode all channels present in the primary audio soundtrack, or may be configured to down-mix the primary audio to less channels.

‘D2’ indicates the secondary audio decoder 320b. ‘D2 (320b)’ decodes the secondary audio stream to LPCM and extracts mixing metadata contained in the secondary audio stream, translating the extracted metadata to a mix matrix format, and then delivers the mix matrix to the first audio mixer 330a. The metadata is used in controlling a mixing process. The secondary audio decoder 320b may be configured to decode all channels present in the secondary audio soundtrack or the 2 channel down-mix contained in a secondary audio bitstream. Each decoded channel output from the secondary audio decoder 320b may be mixed with one or more channels output form the primary audio decoder 320a.

The mix matrix is created in response to mixing parameters. Audio mixing is the ability to sum two gain-controlled (level-controlled) audio streams. Audio mixing can be controlled in each audio mixer of the audio mixing model through use of a mix matrix. The mix matrix includes two sets of coefficients: coefficients to be applied to each channel of the primary stream (‘primary audio stream’ in M1 and ‘output stream of M1’ in M2) and coefficients to be applied to each channel of the secondary stream (‘secondary audio stream’ in M1 330a and ‘interactive audio’ in M2 330b).

The mixing metadata from the secondary audio stream can be a source of mixing parameter available to content providers. Also, command sets can be a source of mixing parameter available to content provider.

The command set is a sort of a program collection to use a function of an application program executable in an optical recording/reproducing apparatus. By the command set, an interface with optical recording/reproducing apparatus functions is configured. By the command set, various functions of the optical recording/reproducing apparatus can be used. As a representative example of the command set, there is an application programming interface (hereinafter abbreviated API). In the following description, the API is taken as an example of the command set.

And, a command set may be stored in a recording medium to be supplied to an optical recording/reproducing apparatus. Yet, a command set can be loaded in an optical recording/reproducing apparatus in manufacturing the optical recording/reproducing apparatus.

The audio mixing model according to the present invention provides a content provider with mixing control parameters (mixing parameter). And, the mixing parameters include a parameter used for panning control of the secondary audio stream, a parameter used for a level control of the primary and secondary audio streams and a parameter used for panning/level control of the interactive audio stream.

In the following description of FIG. 3 and the like, ‘P1’, ‘P2’ and ‘P3’ indicate mixing parameters. Yet, the present invention is not limited to the names of the parameters. And, it is apparent that other parameters can further exist by being unified or separated according to functions.

Meanwhile, a metadata on/off API is able to turn on/off a processing of audio mixing metadata from the secondary audio stream. When a metadata control is on, the P1 mixing parameter provides secondary audio stream metadata control which supports gain (level) control of both primary and secondary audio and panning control of secondary audio streams. When the metadata control is off, the P1 mixing parameter provides panning control of the secondary audio stream. The P1 mixing parameter is provided from either API or from the D2 320b. When the metadata control is on, the P1 mixing parameter comes from the D2 320b. When the metadata control is off, the P1 mixing parameter comes from API.

The P2 mixing parameter provides level control of both primary and secondary audio streams. Level control using a command set (for example, API) combines with metadata level control when the metadata control is on.

Besides, the P3 mixing parameter provides panning and/or level control of interactive audio streams.

In the present invention, the secondary audio is panned and a level of the secondary audio stream is controlled, using the command set.

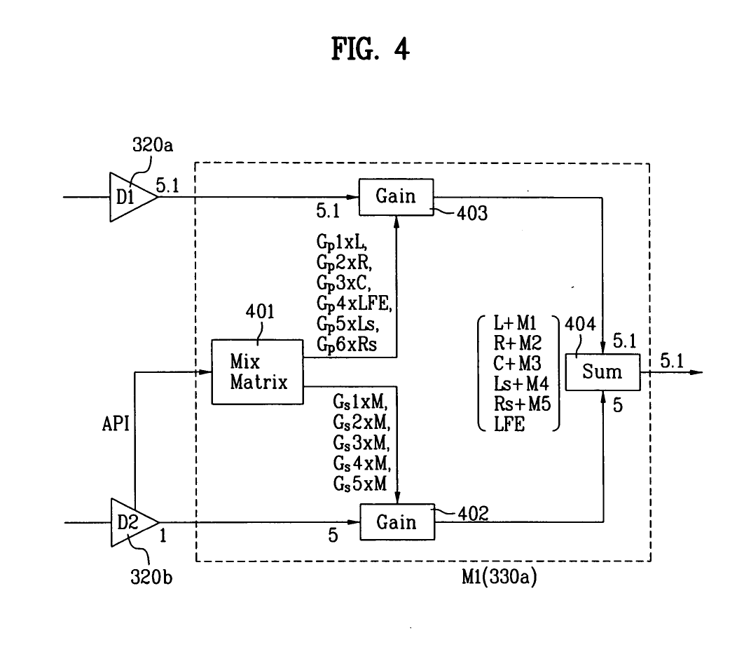

FIG. 4 is a diagram of audio mixing of a first audio mixer according to the present invention, in which a audio mixer M1 330a pans and mixes a secondary audio.

Referring to FIG. 4, the first audio mixer M1 30a mixes a decoded primary audio stream and a decoded secondary audio stream according to a mix matrix 401. An audio mixing process according to the present invention is controlled by a command set. So, a source of mixing parameters P1, P2 and P3 includes a command set. And, the audio mixer M1 330a is controlled by the mixing parameters P1 and P2.

The P1 mixing parameter, as shown in FIG. 3, is switched between the API and the metadata from the secondary audio decoder 320b using the metadata on/off API. In particular, the P1 mixing parameter can be provided from the API or from the secondary audio decoder 320b. P2 mixing parameter is provided from a command set.

The level control provided through the P2 mixing parameter is applied to a mix matrix input provided by P1. Therefore, when the metadata control is on, both the metadata and the command set together control the mixing process.

In the embodiment shown in FIG. 4, the secondary audio stream is mono and the first audio mixer M1 provides 5.1channel output. And, the secondary audio metadata is turned off.

System software in an optical recording/reproducing apparatus according to the present invention translates a panning control API and a level control API to the mix matrix 401, and provides the mix matrix 401 to the first audio mixer 330a.

For the panning of the secondary audio stream, prior to the summation with the primary audio, the secondary audio stream is converted to five channels and the corresponding gains are applied to each of the channels.

Hence, according to the mix matrix 401, the secondary audio becomes ‘Gs1×M, Gs2×M, Gs3×M, Gs4×M, Gs5×5’ (402) and the primary audio becomes ‘Gp1×L, Gp2×R, Gp3×C, Gp4×LFE, Gp5×Ls, Gp×Rs’ (403). And, the primary and secondary audios are summed together (404). An output value 404 of the summing by the first audio mixer M1. 330a is provided to the second audio mixer M2 330b to be mixed with an interactive audio.

In the embodiment shown in FIG. 4, ‘Gs’ means a gain of the secondary audio stream and ‘Gp’ means a gain of the primary audio stream. ‘M’ means mono, ‘L’ means left, ‘R’ means right, ‘C’ means center, ‘S’ means surround, ‘Ls’ means left surround, ‘Rs’ means right surround, and ‘LFE’ means low frequency effect channel.

Besides, the mix matrix 401 is controlled by the P1 and P2 mixing parameters i.e. both P1 and P2 simultaneously dictate the mix matrix 401 which in turn controls the first audio mixer M1 330a.

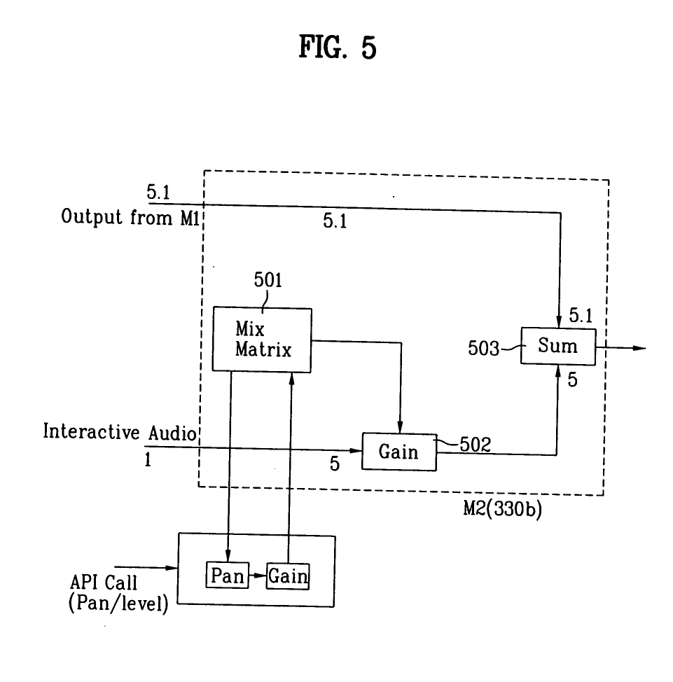

FIG. 5 is a diagram of audio mixing of a second audio mixer according to one embodiment of the present invention, in which a second audio mixer M2 330b performs a mixing process by panning an interactive audio and summing the panned interactive audio and output stream from the first audio mixer M1 330a.

Referring to FIG. 5, an interactive audio is mono. A second audio mixer M2 330b mixes an output stream of a first audio mixer M1 330a and an interactive audio according to a mix matrix 501.

In the present invention, the mixing of the interactive audio is performed by using a mixing metadata. The mixing metadata is stored in a recording medium to be provided to an audio mixer or can be downloaded to storage 15 from an external source of the recording medium along with interactive audio data. The mix matrix 501 can be generated from API or mixing metadata by an optical recording/reproducing apparatus.

The API and/or mixing metadata performs a panning and/or level control of the interactive audio. And, the panning- and/or level-controlled interactive audio 502 is summed to an output stream 404 of the audio mixer M1 330a to be outputted (503).

Although the secondary audio and the interactive audio are mono in the descriptions of FIG. 4 and FIG. 5 for example, it is apparent that the secondary audio and the interactive audio can be stereo or multi-channel streams.

In case of stereo or multi-channel, the secondary audio and the interactive audio can be mixed with the primary audio by level control only without panning. Yet, for more affluent sound, it is able to control a level (gain) after panning of each channel included in an audio stream.

In case that the secondary audio and the interactive audio are multi-channel, a command set used in mixing process according to the present invention is defined according each of channels of the secondary audio and the interactive audio. For instance, in case that a secondary audio includes a channel ‘L’ and a channel ‘R’, a panning and/or level control command set for the channel ‘L’ is defined and a panning and/or level control command set for the channel ‘R’ is defined, separately.

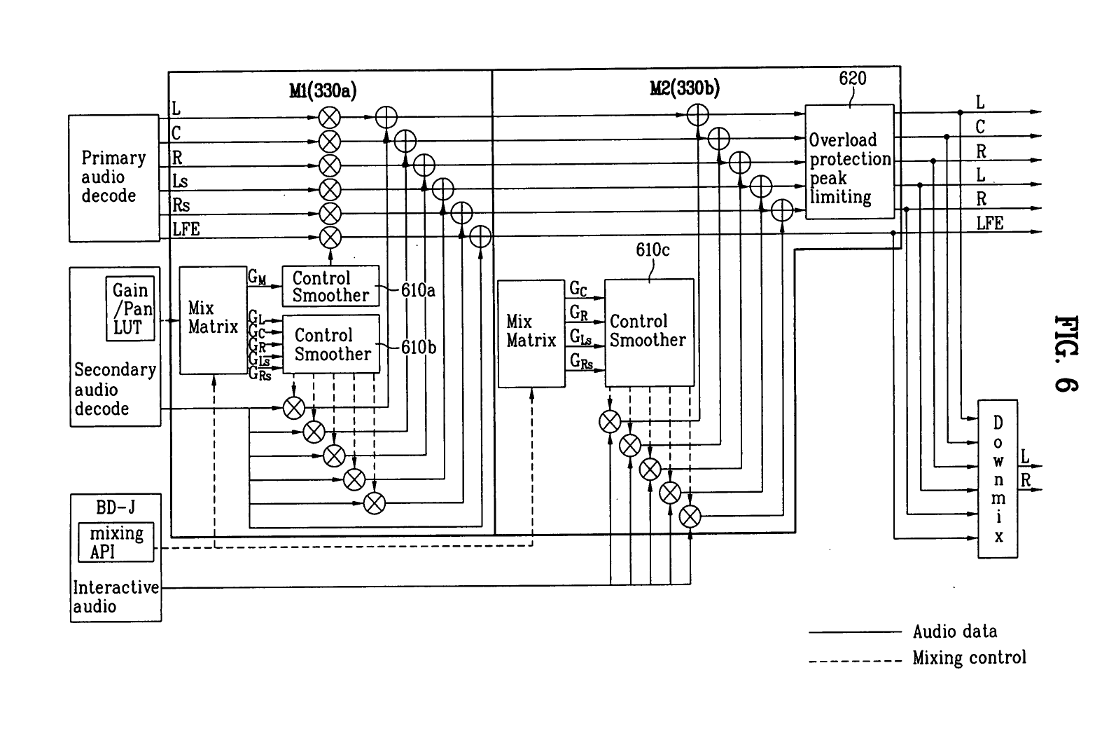

FIG. 6 is a block diagram of an audio mixer according to one embodiment of the present invention.

Referring to FIG. 6, an audio mixer according to one embodiment of the present invention is a 5.1-channel mixer including two mixing blocks.

A first mixing block, i.e., a first audio mixer M1 330a mixes a primary audio stream and a secondary audio stream according to mixing metadata included in the secondary audio stream and/or a command set.

And, a second mixing block, i.e., a second audio mixer M2 330b mixes an output of the audio mixer M1 330a with an interactive audio. A mixing process of the second audio mixer M2 330b is controlled by the mixing metadata and/or the command set.

A gain and pan data included in the secondary audio stream are periodically supplied to the audio mixer at a rate considerably lower than an audio sampling rate. In order to prevent an audible artificial sound (e.g., Zipper noise during fade or panning, click sound due to abrupt gain variation between neighbor audio samples, etc.) from being generated, a gain value delivered via the mixing metadata is smoothened to the audio sampling rate via control smoothers 610a, 610b and 610c.

The decoded secondary audio stream is panned by a mixing API and/or a mix matrix of which ‘Gain/Pan LUT (lookup table)’ is transformed. An output level of the panned secondary audio stream is controlled and is then summed up with the primary audio stream. In this case, the primary audio stream is the decoded data of which output level is controlled according to the mix matrix.

An output value of the first audio mixer M1 330a is provided to the second audio mixer M2 330b to be summed up with the interactive audio. Before being summed up with the output value of the first audio mixer M1 330a, the interactive audio is panned according to the mix matrix generated from the mixing API and/or metadata and its output level is then controlled. A mixing result of the second audio mixer M2 330b is provided to a user as intact or down-mixed.

The mixing of the primary and secondary audio streams takes place at a predetermined time and is controlled by predetermined mixing parameters created during a disc manufacturing process.

By the correct usage of these mixing parameters, it is able to prevent the mixing of the primary and secondary audio streams from inducing an overload of the audio mixer. Yet, the addition of the interactive audio in the second audio mixer M2 330b does not occur at the predetermined time. So, it is probable that an output of the second audio mixer M2 330b will be overloaded. To prevent this, a peak limiting/overload protection 620 is applied to the output value of the audio mixer.

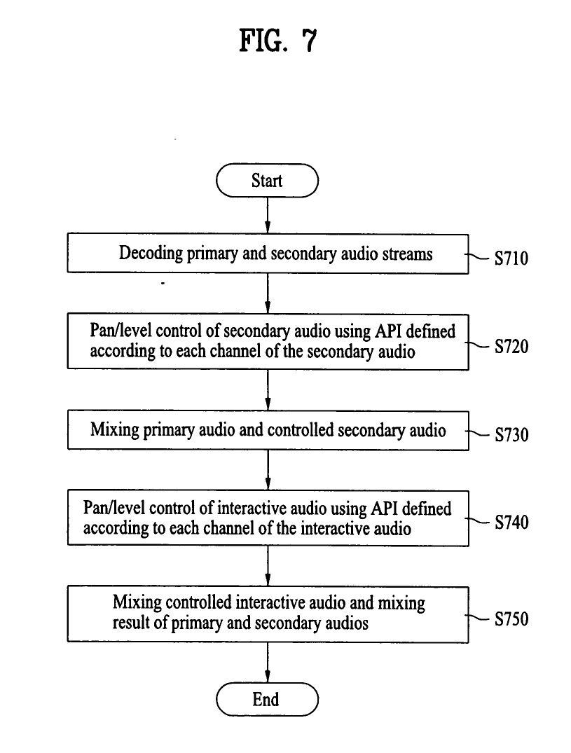

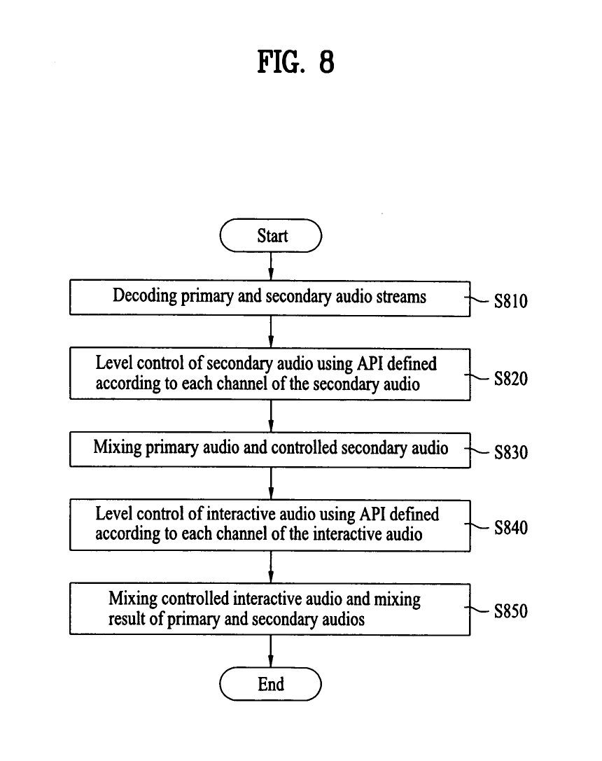

FIG. 7 is a flowchart of an audio mixing method according to one embodiment of the present invention. And, FIG. 8 is a flowchart of an audio mixing method according to another embodiment of the present invention.

In FIG. 7 and FIG. 8, audio mixing is controlled using a command set. A panning control and an output level control are performed in the embodiment shown in FIG. 7, whereas an output level is just controlled in the embodiment shown in FIG. 8.

Referring to FIG. 7, an AV stream of a clip of a transport stream provided from a recording medium and or storage is provided to an audio mixing model. A necessary transport stream is selected according to a PID via a PID filter to be provided to an audio decoder.

A primary audio stream and a secondary audio stream are decoded by a primary audio decoder 320a and a secondary audio decoder 320b, respectively (s710).

The secondary audio stream is panned by a first audio mixer 330a and its level (gain) is controlled (S720). The panning and level controls are performed by using a command set defined according to each channel included in the secondary audio stream, e.g., API (application programming interface). The secondary audio can be mono or multi-channel.

Besides, the panning and the level controls can be performed by using a mix metadata defined according to each of channels included in the secondary audio stream.

The secondary audio stream, which is panned and of which level is controlled, is mixed with the primary audio stream in the first audio mixer 330a (S730). As mentioned in the description of FIG. 4, an output level of the primary audio stream can be controlled according to a mix matrix before being summed with the secondary audio stream.

An output value of the first audio mixer 330a is provided to a second audio mixer 330b. The second audio mixer 330b pans an interactive audio and controls level (gain) of the interactive audio, using a command set defined according to each channel (S740). The interactive audio, which is panned and of which level is controlled, is mixed with the output value of the first audio mixer 330a to be provided to a user (S750). The interactive audio can be mono or multi-channel.

In case that the secondary audio stream is not provided, the output value of the first audio mixer 330a becomes a value resulting from controlling level of the primary audio stream. So, if the secondary audio stream is not provided, the interactive audio is mixed with the primary audio stream of which its level is controlled. Likewise, if the secondary audio is provided and if the interactive audio is not provided, a mixing result of the primary and secondary audios will be provided to a user.

FIG. 8 is a flowchart of an audio mixing method according to another embodiment of the present invention.

Referring to FIG. 8, a command set defined according to each channel included in the secondary audio stream is used for an audio mixing process like FIG. 7. Yet, the embodiment shown in FIG. 8 differs from that shown in FIG. 7 in that a gain control is just performed only without performing panning in case that a secondary audio and/or an interactive audio is multi-channel.

Firs of all, a primary audio stream and a secondary audio stream are decoded to be provided to an audio mixer like the former embodiment shown in FIG. 7 (S810).

Yet, if the secondary audio includes a plurality of channels, a first audio mixer 330a controls an output level of the secondary audio (S820). The first audio mixer 330a then sums it with the primary audio (S830). In other words, the multi-channel secondary audio is not panned in the mixing process. An output value of the first audio mixer 330a is provided to a second audio mixer 330b to be mixed with an interactive audio.

In case that the interactive audio is multi-channel, a level of the interactive audio is controlled by using a command set defined according to each of channels included in the interactive audio(S840), and the controlled interactive audio is summed up with the output value of the first audio mixer 330a to be mixed (S850). Namely, in the embodiment shown in FIG. 8, the multi-channel interactive audio is not panned in the mixing process.

Besides, since the present invention uses metadata for the mixing of the interactive audio, the metadata can be used for the panning and output level control in the embodiments shown in FIG. 7 and FIG. 8. In particular, the metadata is translated to the mix matrix (501) with or without the command set to be used for the level (gain) and/or panning control of the interactive audio.

Accordingly, the present invention enables various audio streams, which are provided from an external input signal and/or a high-density recording medium, to be dynamically mixed, thereby providing more various sounds to a user according to variations of contents provided by content providers.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of mixing audio data, comprising:
a step (a) of decoding a primary audio stream and a secondary audio stream, each of the primary and secondary audio streams including at least one or more channels; and
a step (b) of mixing the decoded primary and secondary audio streams together, the step (b) comprising:
a step (b1) of applying a level control to the decoded secondary audio stream using a command set defined according to each channel of the secondary audio stream; and
a step (b2) of summing the level-controlled secondary audio stream and the decoded primary audio stream.

2. The method of claim 1, wherein the (b-1) step further comprises a step of applying pan control to the decoded secondary audio stream using a command set.

3. The method of claim 1, further comprising;
a step (c) of mixing the mixed primary and secondary audio streams and an interactive audio including at least one or more channels, the step (c) comprising:
a step (c1) of applying a level control to the interactive audio using a command set defined according to each channel of the interactive audio; and
a step (c2) of summing the level-controlled interactive audio and the mixed primary and secondary audio streams.

4. The method of claim 3, wherein the step (c1) step further comprises a step of applying a pan control to the interactive audio using a command set.

5. The method of claim 1, further comprising:
a step (d) of mixing the mixed primary and secondary audio streams and an interactive audio including at least one or more channels, the step (d) comprising:
a step (d1) of applying a pan and/or level control to the interactive audio using mixing metadata defined according to each channel of the interactive audio; and
a step (d2) of summing the controlled interactive audio and the mixed primary and secondary audio streams.

6. A method for mixing audio data, comprising:
a step (a) of decoding a primary audio stream and a secondary audio stream, each of the primary and secondary audio streams including at least one or more channels; and
a step (b) of mixing the decoded primary and secondary audio streams, the step (b) comprising:
a step (b1) of applying a pan and/or level control to the decoded secondary audio stream using mixing metadata defined according to each channel of the secondary audio stream; and
a step (b2) of summing the controlled secondary audio stream and the decoded primary audio stream.

7. The method of claim 6, wherein the mixing metadata is included in the secondary audio stream.

8. An apparatus for mixing audio data, comprising:
a primary audio decoder decoding a primary audio stream including at least one or more channels;
a secondary audio decoder decoding a secondary audio stream including at least one or more channels; and
a first audio mixer mixing the decoded primary audio stream and the decoded secondary audio stream in a manner of applying a level control to the secondary audio stream using a command set defined according to each channel of the secondary audio stream and summing the level-controlled secondary audio stream and the decoded primary audio stream.

9. The apparatus of claim 8, wherein the first audio mixer applies a pan control to the secondary audio stream using a command set.

10. The apparatus of claim 8, further comprising:
a second audio mixer mixing the mixed primary and secondary audio streams and an interactive audio including at least one or more channels in a manner of applying a level control to the interactive audio using a command set defined according to each channel of the interactive audio and summing the controlled interactive audio and the mixed primary and secondary audio streams.

11. The apparatus of claim 10, wherein the second audio mixer applies a pan control to the interactive audio using a command set.

12. The apparatus of claim 8, further comprising:
a second audio mixer mixing the mixed primary and secondary audio streams and an interactive audio including at least one or more channels in a manner of applying a pan and/or level control to the interactive audio using mixing metadata defined according to each channel of the interactive audio and summing the controlled interactive audio and the mixed primary and secondary audio streams.

13. An apparatus for mixing audio data, comprising:
a primary audio decoder decoding a primary audio stream including at least one or more channels;
a secondary audio decoder decoding a secondary audio stream including at least one or more channels; and
a first audio mixer mixing the decoded primary audio stream and the decoded secondary audio stream in a manner of applying a pan and/or level control to the secondary audio stream using mixing metadata defined according to each channel of the secondary audio stream and summing the controlled secondary audio stream and the decoded primary audio stream.

14. The apparatus of claim 13, wherein the mixing metadata is included in the secondary audio stream.

15. A recording medium comprising:
a primary audio stream including at least one or more channels;
a secondary audio stream including at least one or more channels; and
a command set for a level control of the secondary audio stream mixed with the primary audio stream, the command set defined according to each channel of the secondary audio stream.

16. The recording medium of claim 15, further comprising a command set for a pan control of the secondary audio stream mixed with the primary audio stream, the command set defined according to each channel of the secondary audio stream.

17. The recording medium of claim 15, further comprising an interactive audio including at least one or more channels and mixing metadata for a pan and/or level control of a stream of the interactive audio mixed with the mixed primary and secondary streams,
wherein the mixing metadata is defined according to each channel of the interactive audio.

18. A recording medium comprising:
a primary audio stream including at least one or more channels;
a secondary audio stream including at least one or more channels; and
mixing metadata for a pan and/or level control of the secondary audio stream mixed with the primary audio stream, the mixing metadata defined according to each channel of the secondary audio stream.

19. The recording medium of claim 18, wherein the mixing metadata is included in the secondary audio stream.
